(19) United States
(12) Patent Application Publication
(10) Pub. No.: US 2005/0195927 A1
(43) Pub. Date: Sep. 8, 2005

(54) Method and apparatus for conveying messages and simple patterns in communications network

(76) Inventor: Juha Solonen, Jyvaskyla (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/513,446

(22) PCT Filed: Apr. 25, 2003
(86) PCT No.: PCT/FI03/00326

§ 371 Date: Apr. 13, 2005

(30) Foreign Application Priority Data
Apr. 26, 2002 (FI) 20020801

(51) Int. Cl. H04L 1/00

(52) U.S. Cl. 375/346

(57) ABSTRACT

The invention relates to a method and apparatus for generating simple patterns on a terminal and conveying them in a communications network. In the method, an element of a pattern (201, 301) comprising elements is specified and it is assigned a code by which it is identified. The codes of the elements in a pattern are used in compiling a set of codes (303a, 303b, 303c) which describes identified elements of the pattern. The set of codes (303a, 303b, 303c) is sent into a communications network in addition to the message. The receiving device receives, in addition to the message, the set of codes (303a, 303b, 303c) containing the codes of the elements in the pattern (201, 301), which set of codes is analyzed (406) and identified. Element codes included in the set of codes (303a, 303b, 303c) are used to identify elements used to generate a pattern (201, 301).

### CROSS-REFERENCE TO RELATED APPLICATION

This application is the U.S. National Stage of International Application Number PCT/FI03/00326 filed Apr. 25, 2003 and published in the English language Nov. 6, 2003 under International Application Number WO 03/091902 and claiming priority from Finnish Application Number 20020801 filed Apr. 26, 2002.

### TECHNICAL FIELD

The invention relates to a method and apparatus for generating simple patterns on a terminal and conveying them in a communications network.

### BACKGROUND OF THE INVENTION

Mobile network terminals are widely used to communicate not only through speech, as is typical, but also through text messages (SMS, Short Message Service), audio messages and multimedia messages (MMS, Multimedia Messaging Service). Text messages can be used to send a message consisting of characters e.g. between devices that use the GSM (Global System for Mobile communications) network to establish a connection and convey messages. A message can be delivered to a receiving terminal even if the receiving terminal were not active or within a coverage area at the moment of sending. No immediate response is required of the recipient unlike in the case of a voice call, for example.

Messages can also be exchanged between a mobile network terminal and a device in a fixed internet or local area network. In that case there has to be a gateway between them, e.g. a web page. A message can be delivered to a network terminal via the gateway if the terminal is located in a network cell within the coverage area of the gateway or if the gateway functions as a public international gateway for all devices that are capable of roaming. Messages can also be exchanged between digital telephone apparatuses or between them and fixed terminals via gateways. Sending and receiving devices may include e.g. mobile phones, digital phones, smart phones, portable computers, desktop computers and internet and LAN terminals.

So messages can be sent regardless of the recipient, and received in a manner resembling the operation of an answering machine, i.e. messages can be saved for later reading or processing, but in addition to that, messages can also be used for having a conversation, or a chat as it is often called. A chat connection requires active participation, because conversing is done by typing a comment to a message and sending it to a certain storage place of messages. A chat may take place at a certain location, such as a web site, where the messages are stored and to which the users can connect by means of their terminals via a network. Typically, several people can take part in a chat simultaneously. Most chat groups have a certain topic. Conversations may be continuous or they may be scheduled to last for a certain period of time.

Size of messages sent and received by mobile terminals is very limited. Typically it is possible to transfer, in addition to text messages, also picture, data and multimedia messages, and in chat sessions text can be complemented with sound, pictures and video. In that case, however, it is required that the users have hardware and software needed to display, transmit and receive such files. Since the senders and receivers of messages as well as participants in a chat may be using apparatuses which are quite different, it is, for compatibility reasons, safest to use simple character-based messages. Moreover, large files such as pictures slow down network traffic and place a burden on the memory capacity of the receiving terminal. Heaviness and slowness of operation are characteristics that are undesirable in interactive conversation because the real-time feel and interactivity of chatting suffer if participants have to wait for prolonged times before messages are displayed on their terminals. For communication to be as quick as possible, a great number of widely used acronyms have been adopted to be used in chats so that messages can be produced in less time. Table 1 below lists a few examples of such acronyms on the left column with their meanings on the right column.

TABLE 1

| | |
|---|---|
| AFK | Away From Keyboard |
| BBS | Be Back Soon |
| CU | See You |
| F2F | Face to Face |
| IAC | In Any Case |
| IC | I See |
| S\hat{ } | S'up? - What's up? |
| SETE | Smiling Ear to Ear |

Short, quick messages are often enlivened with so-called emoticons which are character-based symbols used to describe emotions. Some mobile phone models, for example, have special menus where the user can choose a suitable emoticon for a piece of text in his/her message. In addition to SMS messages, emoticons are also widely used in email messages, newsgroup and chat messages, and generally in all relatively short text-based messages which do not substantially consume memory when saved and which do not burden the network when transferred. Typically emoticons are horizontally oriented face patterns used to describe emotions or a feeling associated with a text, for example. Table 2 below lists a few examples of emoticons, or smileys as they are sometimes called, on the left column and their meanings on the right column.

TABLE 2

| | |
|---|---|
| :-) | Smiling |
| :<}) | smiling, moustached |
| :-\|\| | Angry |
| :-/ | Baffled |
| 0:-) | Angelic |
| C\|:-= | Charlie Chaplin |
| :-)8 | smiling, wearing a bow tie |
| (:v) | a duck |
| =:O | scared (hair standing on end) |
| :-} | Embarrassed |

Emoticons are used in Japan with even more enthusiasm than in Western countries. The Japanese have come up with emoticons of their own, which are better suited to their culture. Since the Japanese keyboard includes also disyllabic characters, the users can choose between monosyllabic and disyllabic versions of certain characters and this way they can have more nuances with their emoticons, too. Table 3 below lists a few examples of Japanese emoticons on the left column and their descriptions on the right column.

TABLE 3

| | |
|---|---|
| \hat{ }_\hat{ } | a smile |
| \hat{ }o\hat{ };> | excuse me |
| \hat{ }\hat{ }; | cold sweat |
| \hat{ }o\hat{ } | Happy |
| *\hat{ }o\hat{ }* | Excited |
| (\hat{ }_\hat{ })/ | Banzai |

There are numerous different emoticons. Furthermore, as was described above, there are cultural differences between emoticons. Emoticons are popular because they are available to all, they can be easily modified, and they do not require special hardware or software, nor do they significantly consume capacity when saved or transferred. However, the expressive power of emoticons is very limited and while a great number of different emoticons can be compiled from the many character symbols, they remain very general in nature. Another disadvantage of emoticons is their typical presentation: as the emoticons are viewed horizontally so that the left border of normal text or display corresponds to the top border when looking at an emoticon, and the right-hand border of the display corresponds to the bottom border of an emoticon, the user, at each emoticon, has to either tilt his/her head or rotate the display of his/her device by 90 degrees.

### SUMMARY OF THE INVENTION

An object of the invention is to provide a more advanced pattern which is simple, uses little memory, and is easily transferred between terminals even with limited capacity.

The objects of the invention are achieved by generating a set of codes for a pattern so that the pattern can be regenerated using the set of codes. Furthermore, the objects are achieved so that a simple set of codes generated for a pattern is saved in memory when the pattern is being processed, and said set of codes is conveyed via a communications network.

According to a preferred embodiment of the invention, a pattern and a set of codes are generated so that the pattern can be regenerated using the set of codes. The size of a code set according to a preferred embodiment of the invention is measured in dozens of bytes, while the size of a picture file is typically thousands of bytes. As the size of a code set is small, it can be saved without considerably consuming the limited storage capacity of a device processing a pattern. A code set generated according to a preferred embodiment of the invention can be transferred along with the message or separately to the receiving apparatus. Since the code set transferred is small in size, no excessive loading will be imposed on transmission paths, nor will there occur any congestion of connections.

According to a preferred embodiment of the invention, a pattern is generated using a menu. A menu contains elements of a pattern, which may be e.g. facial features, such as different face shapes, hair types, eyes and mouths. Among these menu elements are chosen certain elements according to a set of codes to form a given pattern. The elements are saved only once in the menu, and each of them is referred to by a unique code based e.g. on their position in the menu system. On the basis of the references, i.e. codes, a set of codes is compiled which contains the codes of the elements of a given pattern. The set of codes can be saved and transferred to another device. The receiving device is able to regenerate the original pattern on the basis of the set of codes transferred if the device for example contains a similar menu or has access to the data of a similar menu.

According to another preferred embodiment of the invention, a pattern can be generated from a picture taken with a digital camera, for example. An image recognition algorithm is used to select features, or elements, in the picture. The nearest equivalent elements are selected for the features from a menu. The menu elements selected are used to compile a set of codes for the features of the picture. An image recognition algorithm can be especially designed to recognize certain facial features. Using a pattern according to a preferred embodiment of the invention generated by means of a set of codes instead of an original photograph image, the size of the picture remains small, regeneration of the pattern will not significantly consume the device's capacity, and loading of the pattern will be fast. Therefore, such a simplified pattern is well suited to accomplish or complement a real-time chat.

### BRIEF DESCRIPTION OF DRAWINGS

The invention will now be described in more detail with reference to the accompanying figures where

FIG. 1 shows a menu according to a preferred embodiment of the invention for generating a pattern,

FIG. 2 shows a message according to a preferred embodiment of the invention on a display,

FIGS. 3a-3c show patterns according to a preferred embodiment of the invention,

FIG. 4a illustrates the generation of a pattern according to a preferred embodiment of the invention at a sending terminal, and

FIG. 4b illustrates the generation of a pattern according to a preferred embodiment of the invention at a receiving terminal.

### DETAILED DESCRIPTION OF THE INVENTION

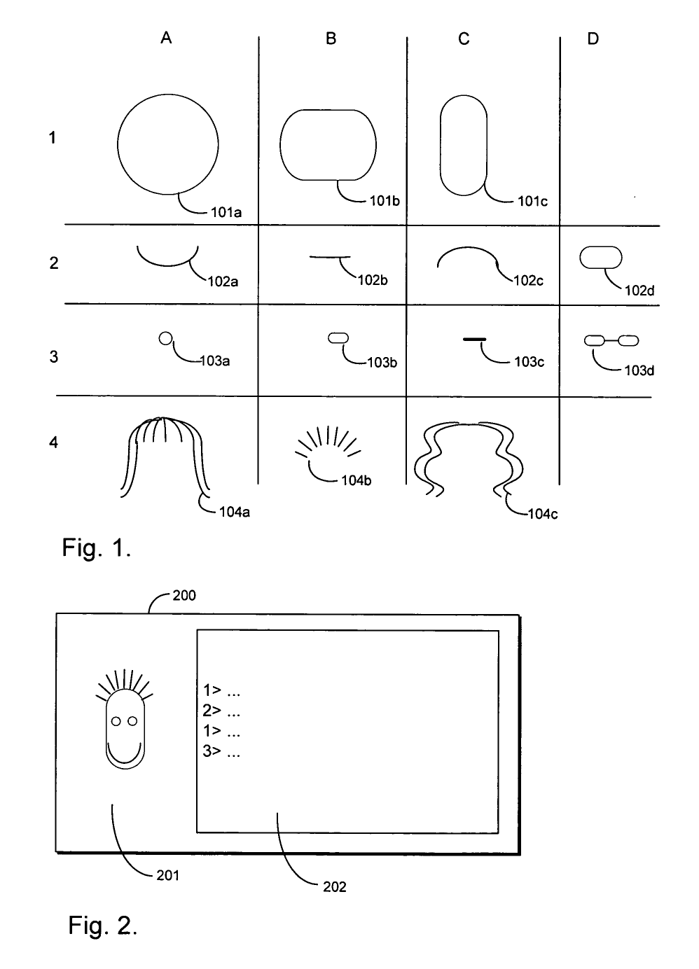

FIG. 1 shows a menu according to a preferred embodiment of the invention, which menu for the sake of example contains a few features for generating a pattern according to the preferred embodiment of the invention. According to this preferred embodiment of the invention, the menu contains elements of a pattern so that a desired pattern can be created by combining different elements. A pattern element is typically a discernible part of a pattern, such as a facial feature or facial shape, for instance. Each pattern element in the menu is associated with a certain code so that an element can be uniquely referred to by using the code associated with it.

In the embodiment depicted in FIG. 1 there are four rows numbered consecutively from 1 to 4, and four columns indicated by letters A, B, C, D. The pattern elements in the first row describe different facial shapes. Row 1, column A contains a round face 101a. Row 1, column B contains a broad face 101b. Row 1, column C contains a narrow, longish face 101c.

The elements in menu row 2 consist of different mouths. Row 2, column A contains a smiling mouth 102a where the corners of the mouth point up. Row 2, column B contains a grave, straight mouth 102b. Row 2, column C contains a sad mouth 102c where the corners of the mouth point down. Row 2, column D contains an open mouth 102d.

The elements in menu row 3 consist of different eyes. Row 3, column A contains a round, open eye 103a. Row 3, column B contains an oval, open eye 103b. Row 3, column C contains a narrow, straight or closed eye 103c. Row 3, column D contains glasses 103d.

Menu row 4 can be used to choose the hair for the pattern to be generated. Row 4, column A contains long, straight hair with a fringe 104a. Row 4, column B contains short, crew-cut hair 104b. Row 4, column C contains curly hair 104c.

In this embodiment, menu elements can be uniquely referred to using a row number/column letter combination. A given element may also be referred to by means of certain keywords so that the keyword ‘mouth’ refers to menu row 2, and the keyword ‘smile’ specifies column A. The menu can be saved in the memory of a device in tabular or list form, for example.

The menu described in the embodiment of FIG. 1 is advantageously located on the terminal. When generating a pattern, one item can be selected in each row to produce a face pattern consisting of the selected features. According to a preferred embodiment, elements need not be selected from every row, but a pattern can be generated using e.g. just the glasses 103d in row 3, column D and the crew cut 104b in row 4, column B. According to another preferred embodiment, the user can choose a plurality of features in one row. For example, he/she could select an open, round eye 103a in row 3, column A for the right eye, and a closed eye 103c in row 3, column C for the left eye.

A menu according to a preferred embodiment of the invention contains many different elements to be combined, thereby making it possible to describe, as well and as individually as possible, a given feeling or emotion associated with a message or to profile oneself. In addition to that which is depicted in FIG. 1, a menu according to a preferred embodiment of the invention further contains different ears, moustaches, hats, glasses, mouth expressions, noses, collars, ties, jewelry and so on. According to another preferred embodiment, the user may define new elements in the menu or edit the features already included in the menu. For example, a user could define a piece of jewelry, tattoo or a piercing to profile him/herself. Typically the patterns according to the invention are face patterns but other simple patterns, such as tattoo patterns or simplified posture patterns, can also be produced. A posture can be described e.g. using a stick figure so that the menu contains different positions of the limbs and body.

According to a preferred embodiment of the invention, a menu containing elements used for generating patterns is located on a network server, for example. According to this embodiment, the user may download a menu or parts of it from the network server to his/her terminal through a WAP (Wireless Application Protocol) link, for example. The WAP includes communication protocols to standardize wireless internet connections. The network may also have additional features or completely new menu entities which the users may download. According to a preferred embodiment, additional properties and features can be purchased from a service provider. In one preferred embodiment, elements and their codes or whole menus can also be exchanged between terminals.

FIG. 2 shows a display 200 divided into an image part 201 and text part 202. The view could be e.g. from a chat connection with multiple simultaneous participants. According to a preferred embodiment of the invention, users may send to the chat server, in addition to text-based messages, pictures to profile themselves. A user may define a pattern, using his/her device to indicate desired features, here e.g. a narrow face, round eyes, bristly hair, and a smile. At the user's terminal each pattern element is associated with a code consisting of character symbols, for instance. These codes are fetched for each element selected by the user, compiled into a set of codes defining the pattern. With this set of codes a pattern can be generated on a display, including the pattern elements, properties and features defined by the user. The user sends this code set e.g. to the chat site, where the pattern can be regenerated in the image part 201 of the display 200. The code set compiled according to the elements chosen by the user can be linked to a message and sent together with it. The message may be a text (SMS) message, audio message or a multimedia (MMS) message. The code set can be visible to the recipient or it can be replaced by a control character or similar indication of a code set.

According to a preferred embodiment of the invention, a chat participant may send to the chat site the following message where the code set is embedded in the message, separated by curly brackets from the rest of the text.

I {I:1A,2D,3D,4C} had {I2:2B} a tense discussion {S:5_4} with my colleague. I wasn't pleased with his work {I2,3:2C,3C+3C}.

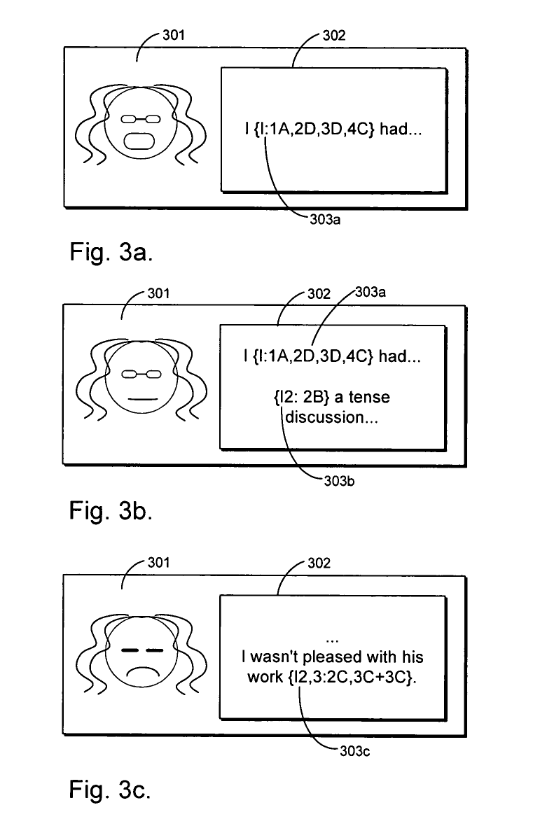

In the embodiment depicted in FIG. 3a, the beginning of a message and a first code set 303a in curly brackets are displayed in the message part 302 of the display, and an image (I) generated according to the code set is displayed in the image part of the display. The elements defined in the code set are a round face 1A, open mouth 2D, glasses 3D, and curly hair 4C. The continuation to the message is shown in the message part 302 of FIG. 3b where there is the text and code set 303a shown in FIG. 3a and the text following it and a code set 303b associated with the latter. I2 at the beginning of the code set 303b means that element 2 shall be changed in the pattern defined earlier. After that it is specified that the earlier element 2 is now replaced by element 2B, which in the menu shown in FIG. 1 is a straight mouth. The pattern thus generated is displayed in the image part 301 of FIG. 3b. The next code set {S:5_4} in the message above refers to a memory location 5_4 for sounds (S), from which memory location a sound is fetched and generated at this point of the message by means of a sound reproduction component in the device.

In the previous embodiment, the mouth in the pattern may be alternately open and closed, thereby creating an illusion that the pattern is talking to the recipient. Patterns can be updated at a pace even this quick in accordance with the message, because simple patterns are generated immediately on the display and, moreover, the code set only requires a space of a few characters. The last code set 303c in the above message, shown in FIG. 3c, changes both the mouth and the eyes, the elements in row 2 and 3 respectively. This change is represented by the symbol I2,3 at the beginning of the code set. Selection 2C is a sad mouth, and the eyes 3C are straight lines. The pattern thus generated is displayed in the image part 301 of FIG. 3c.

In the above description, an image (I) and a sound (S) were defined by means of codes. According to a preferred embodiment of the invention, various sound patterns or an animated image, for example, can be defined in a similar manner to accompany a message. A message may be accompanied by sounds generated from real sound samples, mechanical sounds or similar sounds stored in memory, which sounds can be referred to and which can be edited using certain codes. The sound patterns used are stored in the memory of the device. Sound patterns are reproduced by means of sound reproduction components in the device. An animated image may be produced e.g. such that a certain movement is selected for a certain element of a pattern from a menu, and reference is made to the movement using a certain code. For example, eyes can be made to blink, a stick figure to jump, or hands to clap. The movement selected from the menu may be e.g. such that a whole pattern or a given element is flashed on and off, moved along a certain track back and forth or in circles, moved along the edges of the picture area of the display or randomly within the picture area.

The previous examples describe how elements in a menu according to a preferred embodiment of the invention can be uniquely referred to. However, reference can be made to menu features using other designators or in some other way, e.g. by numbering or otherwise identifying the elements unambiguously, whereby their position in the menu, table or similar structure is not necessarily fixed. For example, a menu may have certain headers such as the mouth, eyes, nose and so on, for which there are subheaders, i.e. elements that are identified and that can be referred to using descriptive words, ordinal numbers or in some other applicable manner. In addition, parameters can be used to set a volume level for a selected sound or a speed for a movement. According to a simple embodiment, these quantities are increased when a plus sign follows the sound or movement code, and decreased when a minus sign follows the sound or movement code.

A set of codes according to a preferred embodiment of the invention for generating a given pattern is conveyed along with a message. It is also possible to send just the set of codes to a recipient. Typically, a recipient will not see the code sets shown above in curly brackets, but the code sets can be hidden in the message, for example. The code sets may also be located somewhere else, e.g. they may follow the message separately, whereby the message contains e.g. a link, control button or some other pointer on the basis of which the code set is retrieved at a certain point in the message.

A receiving device according to a preferred embodiment has to be capable of generating a pattern on the basis of a set of codes sent to it. Typically, the receiving device has a menu, for example, which contains the elements in the pattern. The original pattern can be regenerated using the data in that menu and the set of codes. Alternatively, the data required can be fetched from a menu on a network server, for example. This requires a network connection with the site where the menu or the corresponding data are located.

When the receiving device gets the set of codes within a message or as separate data, the pattern can be generated on the basis of the set of codes immediately after the set of codes is received. If the code set is embedded in the message, the pattern is generated advantageously when the user activates the message part in question, i.e. reads the text message, for instance, and the cursor is at the code set or at the character or button indicating the code set. According to a preferred embodiment, the pattern is generated when the control character indicating the code set is activated by e.g. clicking on it or upon accepting the activation. According to another preferred embodiment, the cursor progresses in the text according to an estimated reading rate of the user, and when the cursor comes to a set of codes, the appropriate pattern is generated.

According to an embodiment, the code-based generation of patterns on the display can be disabled in software. In addition, certain default values can be defined for unidentified elements. If, for example, a user sends a face pattern where the eyes have been edited by him/her, the receiving device is not able to generate the eyes unless the sender gives an accurate description and code of the eye elements edited by him/her. The default may be that an unidentified element is not rendered at all, or if e.g. an element is recognized as eyes, based on a row number, but the column number refers to an empty location, a certain eye element, such as that in the first column of the menu, can be used in the pattern generated.

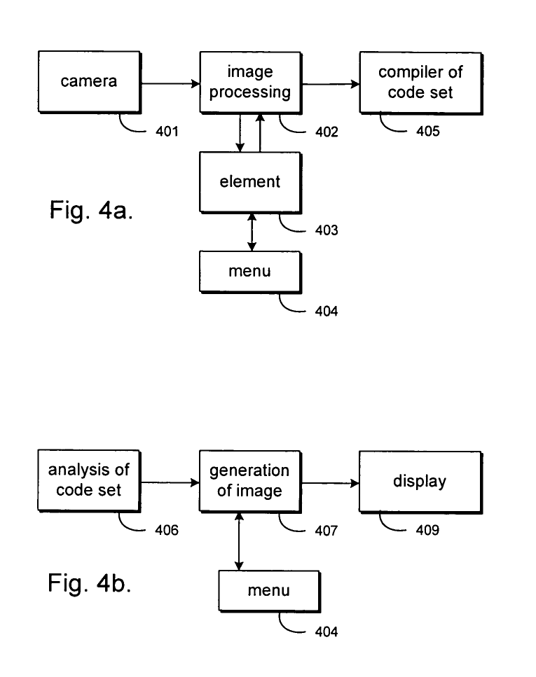

According to a preferred embodiment of the invention, a pattern is generated e.g. by means of a digital camera, as depicted in FIG. 4a. An image produced by the camera 401 is sent to an image-processing component 402 where an image recognition algorithm is applied in order to find pattern elements 403 such as outlines, features, edges and shadows. These are matched against elements in a menu according to a preferred embodiment of the invention. For each element, such as e.g. shape of head, eyes, nose and mouth, found in image processing 402, the code of the menu element that best matches the element found is fetched from the menu 404. The difference between an element found in the image produced by the camera and a menu element can be computed or modeled in some other known way so as to find the best matching elements, features and shapes. A pattern and a set of codes for it are thus generated, said pattern being a reduced version of the image produced by the camera but, however, including features and elements of the original. The set of codes 405 is compiled based on element codes selected from the menu 404. The menu shown in FIG. 4a can also be used to generate a pattern without a camera, manually, so that features are selected from the menu 404 and a set of codes 405 is compiled from those features. When the set of codes 405 has been compiled, it can be transferred to another terminal where the pattern can be regenerated on the basis of the set of codes. It should be evident that a pattern can also be generated using a combination of the above described techniques, e.g. using menu elements to edit a picture originally produced by a camera.

FIG. 4b shows a device which receives a code set. The code set 406 is analyzed, and a technique, such as a menu, by means of which the pattern is to be generated, is selected on the basis of the code set used. Patterns may use different code sets and the receiving device has to identify the code set used to be able to generate a pattern according to it. A code set compiled from an image taken with a camera may consist of pixels of certain features, for example. Elements that make up the pattern are fetched from the menu 404 on the basis of individual codes in the code set identified in conjunction with image generation 407. The pattern generated on the basis of the elements defined by the codes in the code set is shown on a display 409.

Typically, so-called edges are searched for in an image produced by a camera. Facial features such as eyes, nose and mouth have very sharp edges. The contrast of the original image is a significant factor as regards the recognizability of features and, generally, pattern elements. Individual points, instead of lines describing features, produce the sharpest regenerated pattern. That, however, requires a lot of processing power in the equipment used. Typically, a reduced image regenerated on the basis of a code set is not recognizable any more. In chat groups, for example, recognizability is not even wanted, but the image is meant just to emphasize certain selected features to cause a certain imagery.

Patterns can be edited as desired, e.g. by means of image editing software. A pattern or a given element in it can e.g. be twisted or stretched in a certain direction. According to an embodiment of the invention, a pattern can be edited using menu elements, by changing or adding menu elements in/to the pattern. A code set compiled can be saved for later use. Edited features can also be saved in the menu.

An image produced by a camera can be advantageously kept as a template which can be used to produce edited versions, emphasizing certain elements. One such version could be used e.g. as a user profile for a chat group, and it could be stored by a service provider, in a network, on a server or somewhere else from which place the user can fetch it when necessary. Special image banks can be established in a network, where images can be saved and retrieved for later use.

One factor influencing the code set and the simplified pattern generated on the basis thereof is the algorithm used in image recognition. If the equipment has enough processing power and it is possible to perform image recognition in real time, a simplified, real-time image from a camera can be sent to a receiving device. This requires that the sending device itself has or is connected to a camera, for instance to a video camera, to generate an image in real time. This requires that the camera has certain rate of shooting, i.e. the camera can produce certain number of images per second. Certain elements are searched for in the image e.g. at certain intervals, and elements found are used to compile a code set to be transferred to the receiving device. Especially in real-time applications, the data also has to be transferred at a fast rate, and the receiving device has to be able to generate the pattern based on the code set immediately. In real-time applications the receiving device adavantageously uses some synchronizing mechanism and buffering to keep the datastream steady.

1. A method for conveying a message including a pattern, comprising the steps of:
specifying an element (403) of a pattern (201, 301) comprising elements,
assigning a code for the element (403) specified to identify the element (403),
compiling a set of codes (303a, 303b, 303c) containing codes of pattern elements (403), and
conveying the set of codes (303a, 303b, 303c) to a communications network in addition to the message, wherein image and sound elements are identified by means of codes.

2. A method according to claim 1, wherein the set of codes (303a, 303b, 303c) of a pattern comprising elements (403) is specified as a response to commands given manually by the user.

3. A method according to claim 2, further comprising the step of, in response to a command directed to an element in a menu (404) of a device and given manually by the user, reading the code of the element in question from a table stored in memory, which table maps elements of the menu (404) to the respective codes.

4. A method according to claim 1, further comprising the steps of producing a digital image by a camera (401), specifying an element (403) in the digital image by matching a feature in the image detected by an image recognition algorithm (402) against elements in a menu (404) containing elements, and fetching a code of the element specified from a table which maps elements to respective codes.

5. A method according to claim 4, comprising the steps of matching a feature in an image detected by an image recognition algorithm (402) against certain mutually alternative elements in the menu (404) containing elements, and from alternative elements in the menu (404) selecting an element which best matches the feature detected in the image produced by the camera (401).

6. A method according to claim 3, wherein the menu (404) containing elements is fetched from a communications network.

7. A method according to claim 1, wherein the set of codes (303a, 303b, 303c) compiled on the basis of element (403) codes is stored on the device.

8. A method for receiving a message including a pattern, comprising the steps of:
receiving in addition to the message, a set of codes (303a, 303b, 303c) containing codes of pattern (201, 301) elements (403),
analyzing the set of codes received (406),
identifying a certain element by means of an element (403) code included in the set of codes (303a, 303b, 303c), and
generating a pattern (201, 301) on the basis of identified elements, wherein image and sound elements are identified by means of codes.

9. A method according to claim 8, wherein the set of codes (303a, 303b, 303c) and an element (403) associated with a certain code are identified by means of a menu (404) containing elements.

10. A method according to claim 8, further comprising the step of receiving in addition to the message and the set of codes (303a, 303b, 303c), also a menu (404) containing elements.

11. A method according to claim 8, wherein the set of codes (303a, 303b, 303c) is received on a communications network terminal, where the set of codes is analyzed (406), elements are identified on the basis of codes in a menu (404) that belong to the set of codes (303a, 303b, 303c), and a pattern (407, 409) is generated using the identified elements.

12. A method according to claim 8, wherein the set of codes (303a, 303b, 303c) is received on a communications network server, where the set of codes (303a, 303b, 303c) is used to generate a pattern (201, 301) which can be observed on a terminal connected to the server.

13. A method according to claim 8, wherein the received set of codes (303a, 303b, 303c) is referred to in a received message, and a pattern is generated on the basis of the set of codes (303a, 303b, 303c) at a point in the message which refers to the set of codes (303a, 303b, 303c).

14. A device for conveying a message including a pattern, the device comprising:
means for specifying elements of a pattern (201, 301) comprising elements (403);
means for assigning a code to each pattern (201, 301) element (403) specified;
means for compiling (405) a set of codes (303a, 303b, 303c) containing the codes of the pattern elements (403); and
means for conveying the set of codes (303a, 303b, 303c) to a communications network in addition to the message, wherein the pattern includes image and sound elements.

15. A device according to claim 14, further comprising means for specifying pattern (201, 301) elements manually.

16. A device according to claim 14, further comprising means for generating an image with a camera (401).

17. A device according to claim 16, further comprising means for specifying pattern elements (403) by means of an image recognition algorithm (402).

18. A device according to claim 17, further comprising means for matching specified elements against mutually alternative elements in a menu (404) in the device in order to find the menu (404) element that best matches a specified element.

19. A device according to claim 14, further comprising means for receiving and saving a menu (404) containing elements of a pattern.

20. A device according to claim 14, further comprising means for saving the set of codes (303a, 303b, 303c) compiled.

21. A device according to claim 14, wherein the set of codes (303a, 303b, 303c) includes a code which refers to a certain menu (404) element.

22. A device according to claim 14, wherein the set of codes (303a, 303b, 303c) includes recognizable elements (403) of a pattern (201, 301) defined through codes.

23. A device for receiving a message including a pattern, the device, comprising:
means for receiving, in addition to the message, a set of codes (303a, 303b, 303c) containing codes of pattern (201, 301) elements;
means for analyzing (406) and identifying the set of codes (303a, 303b, 330c);
means for identifying an element on the basis of an element code included in the set of codes (303a, 303b, 303c); and
means for generating (407) a pattern by means of identified elements, wherein the pattern includes image and sound elements.

24. A device according to claim 23, further comprising a menu (404) which contains elements of a pattern.

25. A device according to claim 24, further comprising means for generating a pattern (201, 301) on the basis of codes in a set of codes (303a, 303b, 303c) and corresponding menu (404) elements.

26. A device according to claim 23, further comprising means for producing a pattern (201, 301) according to a set of codes (303a, 303b, 303c) as a response to the activation of a message part which refers to the set of codes (303a, 303b, 303c).
